(19) United States
(12) Patent Application Publication
(10) Pub. No.: US 2021/0023753 A1
(43) Pub. Date: Jan. 28, 2021

(54) MOLDED ARTICLE MANUFACTURING METHOD

(71) Applicant: Konica Minolta, Inc., Chiyoda-ku, Tokyo (JP)

(72) Inventor: Dai AKUTSU, Midori-ku, Sagamihara-shi, Kanagawa (JP)

(73) Assignee: Konica Minolta, Inc., Chiyoda-ku, Tokyo (JP)

(21) Appl. No.: 16/977,826

(22) PCT Filed: Mar. 5, 2019
(86) PCT No.: PCT/JP2019/008486

§ 371 Date: Sep. 3, 2020

(30) Foreign Application Priority Data
Mar. 5, 2018 (JP) 2018-038988

(51) Int. Cl. B29C 45/14

(52) U.S. Cl. CPC B29C 45/14467; B29L 2011/0016

(57) ABSTRACT

The present invention provides a molded article manufacturing method that is simple but does not leave a holding mark on an optical film. By the molded article manufacturing method, the functional surface of an optical film that is not greater than 10 nm in the Ra value of surface roughness is attached to the optical surface forming portion of an injection mold that is not greater than 10 nm in the Ra value of surface roughness, so that the injection mold is made to hold the optical film. A molten resin is supplied into a mold space formed by the injection mold, and the molten resin is hardened to form a molded article body. The molded article body and the optical film are integrated.

### TECHNICAL FIELD

The present invention relates to a method for manufacturing a molded article into which an optical film is integrated, and more particularly, to a method for manufacturing an optical window and other molded articles.

### BACKGROUND ART

There are known sensor devices that identify the size, the velocity, the distance from a sensor, and the like of an object by utilizing light reflected from the detection target as a result of emission of laser light. The exterior component of a sensor device includes an optical window to allow light in the laser wavelength region to pass. However, there is a possibility of use outdoors for surveillance purposes and the like. Therefore, the exterior component is required to have not only an optical function but also have weather resistance against sunlight, rain, and the like, and scratch resistance against the optical window. As a conventional exterior component manufacturing method, a hard coating treatment by dipping is performed after molding of a component. However, a batch method is normally used as a processing method, and the number of films that can be formed at once depends on the product size. Therefore, the film formation costs increase with the increase in size of the product. In other words, the proportion of the film formation costs to the total manufacturing costs becomes higher, and the yield at the time of film formation greatly affects the costs. In view of this, an insert molding method (hereinafter referred to as the film insert molding method) is used. By the film insert molding method, a film prepared beforehand mainly for decoration and surface protection is disposed in a mold, and the film is integrated with the surface of a resin molded article at the same time as injection molding (see Patent Literature 1). As a result, the film formation batch process after the injection molding becomes unnecessary, and the manufacturing costs can be dramatically lowered.

In the film insert molding method described above, a vacuum hole for vacuum suction of a film is normally formed in a mold, to hold the film in the mold before molding. However, depending on the position of the vacuum hole, a suction mark is left on the optical surface, and a new mold for insert molding needs be manufactured. On the other hand, a holding method by which a film is attached directly to the inner surface of a mold is a simple and highly-productive method. However, there are no disclosures of any specific method for attaching a film directly to a mold at a time of film insert molding.

### CITATION LIST

### Patent Literature

Patent Literature 1: JP 2001-232659 A

### SUMMARY OF INVENTION

The present invention has been made in view of the background art described above, and aims to provide a molded article manufacturing method that is simple but does not leave a holding mark on an optical film.

To achieve at least one of the objects described above, a molded article manufacturing method that reflects one aspect of the present invention includes: causing an injection mold to hold an optical film, by attaching the functional surface of the optical film that is not greater than 10 nm in the Ra value of surface roughness to the optical surface forming portion of the injection mold that is not greater than 10 nm in the Ra value of surface roughness; and forming a molded article body and integrating the molded article body and the optical film, the molded article body being formed by supplying the molten resin into a mold space formed by the injection mold and hardening the molten resin.

### BRIEF DESCRIPTION OF DRAWINGS

FIGS. 1A to 1C are a perspective view, a cross-sectional view, and a plan view for explaining the main exterior unit of an exterior component for a laser sensor device.

FIG. 2 is an enlarged cross-sectional view for explaining a cross-section structure of an optical window.

FIG. 3 is a schematic diagram for explaining a laser sensor device including the main exterior unit shown in FIG. 1A and others.

FIGS. 4A to 4C are views for explaining a method for manufacturing the main exterior unit of an exterior component.

FIGS. 5A to 5D are views for explaining a method for manufacturing the main exterior unit of an exterior component.

FIG. 6A is a perspective view for explaining attachment of an optical film to a first mold, and FIGS. 6B and 6C are perspective views of the front side and back side of a provisional attachment jig.

FIG. 7A is a perspective view of the back side of a main attachment jig, and FIG. 7B is a side view of the main attachment jig.

FIG. 8A is a view showing an optical film sticking to a mold surface in a case where the value of the surface roughness Ra of the optical film is not greater than 9.9 nm, and FIG. 8B is a view showing the state of an optical film in a case where the value of the surface roughness Ra of the optical film is not smaller than 27 nm.

FIG. 9 is a view showing a state in which an optical film is placed on a flat surface of a metallic flat plate, and air bubbles have not yet been removed by a spatula.

### DESCRIPTION OF EMBODIMENTS

The following is a description of an embodiment of a molded article manufacturing method according to the present invention, with reference to the drawings. A molded article to be manufactured by the manufacturing method is optical components that are an optical window and others, but the following description mainly concerns a method for manufacturing exterior components of a laser sensor device.

[Exterior Component as an Optical Component]

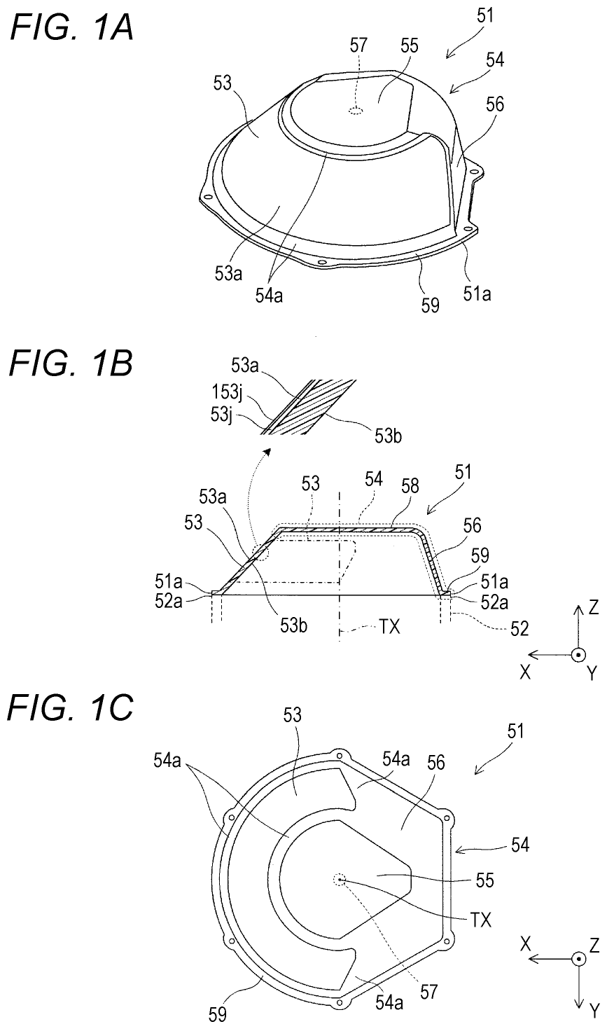

FIGS. 1A to 1C are a perspective view, a cross-sectional view, and a plan view for explaining the main exterior unit of the exterior component of a laser sensor device. The main exterior unit 51 shown in the drawings has an optical function of transmitting a specific light beam, and has an external form like a circular truncated cone.

The main exterior unit 51 has a dome-like appearance, and includes an optical window 53 and a holding portion 54. The optical window 53 and the holding portion 54 constitute an integrally-molded article made of a resin that is transparent in the wavelength region of laser light L1. The optical window 53 and the holding portion 54 are made of a material that is not only transparent to the laser light L1 but also blocks ambient light outside the wavelength region of the laser light L1. Specifically, if the laser light L1 is an infrared ray having a specific wavelength (light having a wavelength of 900 nm, for example), the optical window 53 is preferably made of a resin material that allows 80% or more of the wavelength to pass, for example, and blocks most of the visible ambient light (light having a wavelength not shorter than 400 nm and not longer than 700 nm, for example). Such a resin may be PMMA, PC, COP, or the like, whose transmittance in the visible light region is lowered by an additive such as a dye or a pigment, for example. Note that the material of the optical window 53 and the holding portion 54 is preferably a material that relatively reduces transmission of other infrared rays that have different wavelengths from that of the laser light L1 and might turn into noise.

The optical window 53 of the main exterior unit 51 allows the laser light L1 and reflected light L2 to pass, has a uniform thickness, and is curved as a whole. The optical window 53 has a pair of curved optical surfaces facing each other: a first optical surface 53a and a second optical surface 53b. The first optical surface 53a is the surface on the front side, which is the outer side, of the exterior component 50, and specifically, is a conical surface. The second optical surface 53b is the surface on the back side, which is the inner side, of the exterior component 50, and specifically, is a conical surface. Both optical surfaces 53a and 53b are positioned substantially symmetrically about a reference axis TX. The surfaces of the optical window 53 (which are the first and second optical surfaces 53a and 53b) have a gradient with respect to the reference axis TX. As the optical window 53 has a gradient with respect to the reference axis TX, it is possible to reduce the size of the exterior component 50 while preventing backward travel of the laser light L1 that is projected light in the optical window 53.

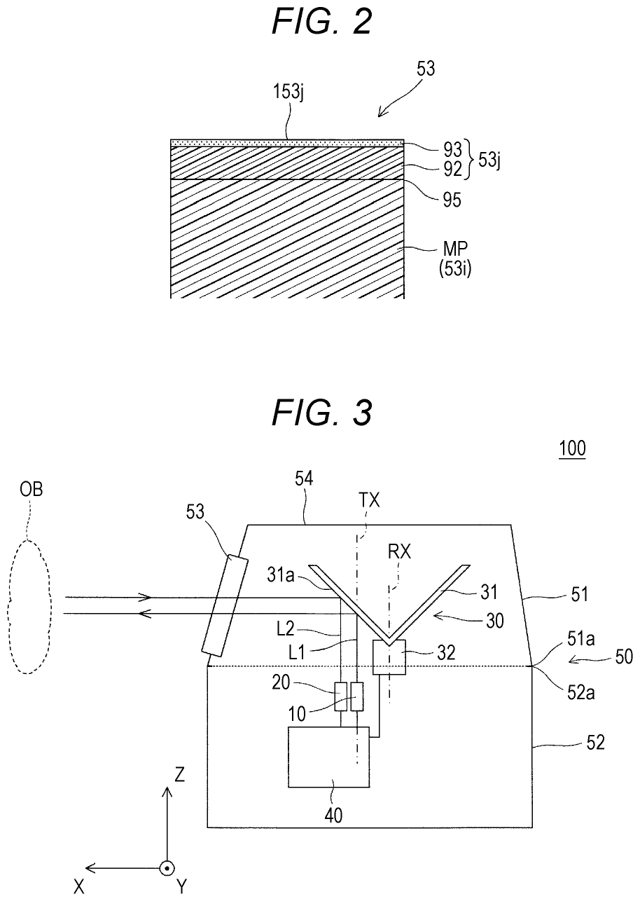

As shown in an enlarged view in FIG. 2, the optical window 53 includes a molded article body 53i and an optical film 53j. The molded article body 53i is a portion shared with the holding portion 54. The optical film 53j is integrated with the molded article body 53i so as to cover the surface of the molded article body 53i. The main exterior unit 51 including the molded article body 53i and the optical film 53j is formed by insert molding. That is, the optical film 53j is fixed to the main exterior unit 51, being fused with the main exterior unit 51 or the molded article body 53i at the boundary with the main exterior unit 51. The optical film 53j is formed with a hard coat layer 93 and a film base material 92 that are integrated with each other. The optical film 53j has the hard coat layer 93 as a functional layer on side of a functional surface 153j. The total thickness of the optical film 53j is not smaller than 25 μm and not greater than 300 μm. As the total thickness of the optical film 53j is not smaller than 25 μm, decrease in the strength of the optical film 53j is reduced so that deformation and degradation of the optical film 53j can be avoided. On the other hand, as the total thickness of the optical film 53j is not greater than 300 μm, increase in the hardness of the optical film 53j is reduced so that the optical film 53j can be prevented from becoming undeformable to such a degree that the optical film 53j becomes unable to follow the optical surface forming portion. The hard coat layer 93 enhances the strength of the optical film 53j, and reduces the occurrence of scratches and the like that will cause resolution degradation in the optical window 53 exposed to the outside. The hard coat layer 93 is formed beforehand on the film base material 92 by coating. The hard coat layer 93 is a resin such as a silicone resin, for example, but may be an acrylic or urethane organic film or a material to which an additive such as fluorine or SiO₂ has been added. A silicone resin excels in hardness and durability, and has a high transmittance. Like the molded article body 53i, the film base material 92 is formed with a material that has a good transparency to the laser light L1, and PET, PMMA, PC, or the like is used, for example.

Referring back to FIG. 1A and others, the holding portion 54 surrounds the outer circumference of the optical window 53, and includes a frame portion 54a that supports the outer edge of the optical window 53, a lid portion 55 that extends parallel in the X-Y plane from the +Z side, which is the upper edge of the frame portion 54a, and a wall portion 56 that extends from the side edges of the frame portion 54a toward the −X side, which is the back surface side. At the center of the lid portion 55, a gate portion 57 associated with molding is formed. The holding portion 54, which is the frame portion 54a, the lid portion 55, and the wall portion 56, has a light blocking portion 58 that is adjacent to and surrounds the first optical surface 53a, and blocks laser light and ambient light (see FIG. 1B). In this embodiment, the light blocking portion 58 is provided in a layered form on the outer surface of the holding portion 54 of the main exterior unit 51 excluding the optical window 53. The light blocking portion 58 is formed by applying or vapor-depositing a material that blocks laser light and ambient light. The material of the light blocking portion 58 may be a light-blocking coating material formed with a silicone-based or urethane-based material colored with a pigment or the like of any appropriate color such as white or black, for example. An annular connecting portion 59 for detachably connecting to a sub exterior unit 52 that is a separate member is disposed at the edge portion of the holding portion 54 (that is, the edge portion 51a of the main exterior unit 51). The connecting portion 59 extends flat along the X-Y plane.

The sub exterior unit 52 is a mating component to which the main exterior unit 51 is attached. The sub exterior unit 52 is connected to the main exterior unit 51 to form a space, and houses an optical component. The sub exterior unit 52 is made of a resin having a light blocking effect, for example, and this resin preferably has a linear expansion coefficient similar to that of the main exterior unit 51. The sub exterior unit 52 may be made of the same resin as the main exterior unit 51. In this case, however, the same portion as the light blocking portion 58 is formed by coating or the like to secure a light blocking effect. Although not shown in the drawings, a connecting portion for connecting to the main exterior unit 51 is also provided at the edge portion 52a of the sub exterior unit 52.

[Laser Sensor Device]

FIG. 3 schematically shows the structure of a laser sensor device 100 including an exterior component. The laser sensor device 100 is an object detection device for indoor/outdoor surveillance and in-vehicle use, for example, and detects the presence of a detection target and measures the distance to the detection target. The laser sensor device 100 includes a light projecting unit 10, a light receiving unit 20, a rotary reflecting unit 30, a control unit 40, and the exterior component 50. The light projecting unit 10, the light receiving unit 20, the rotary reflecting unit 30, and the control unit 40, which are internal components of the laser sensor device 100, are disposed inside the exterior component 50.

The light projecting unit 10 of the laser sensor device 100 projects the laser light L1 onto the reflecting mirror 31 of the rotary reflecting unit 30 described later. Although not shown in the drawing, the light projecting unit 10 has a laser light source and a coupling lens. The former laser light source emits pulsed light as the laser light L1 at a predetermined timing by operating under the control of the control unit 40. The latter coupling lens is disposed in the light path between the laser light source and the rotary reflecting unit 30, and makes the laser light L1 parallel light or slightly diverging light. The laser light L1 is reflected by the reflecting mirror 31, and is emitted to the side of the detection target OB, which is the outside of the exterior component 50, via the optical window 53 of the exterior component 50 described later.

The light receiving unit 20 receives reflected light L2 from the detection target OB. The reflected light L2 is the light reflected by the reflecting mirror 31 of the rotary reflecting unit 30 after passing through the optical window 53 of the exterior component 50. More specifically, when there is a detection target OB such as an object in the detection region, the laser light L1 emitted from the laser sensor device 100 is reflected by the detection target OB, and part of the light reflected by the detection target OB is returned as the reflected light L2 to the light receiving unit 20 of the laser sensor device 100. Although not shown in the drawing, the light receiving unit 20 includes a condenser lens and a sensor. The former condenser lens is disposed in the light path between the rotary reflecting unit 30 and the sensor, and condenses the reflected light L2. The latter sensor is a one-dimensional or two-dimensional photodetection device that operates at high speed. The sensor receives the reflected light L2 via the condenser lens, and outputs a signal corresponding to the amount of received light and the light reception position, to the control unit 40.

The rotary reflecting unit 30 includes the reflecting mirror 31 and a rotary drive unit 32. The reflecting mirror 31 is a single-reflection polygon mirror, and has a reflecting portion 31a for light path bending. The reflecting portion 31a has a pyramidal shape that has its central axis in the Z-axis direction. The reflecting mirror 31 rotates about a rotation axis RX extending parallel to the Z-axis, and scans the laser light L1 along the X-Y plane. In the reflecting mirror 31, the mirror surface of the reflecting portion 31a is inclined with respect to the Z-axis, and reflects the laser light L1 entering from the Z direction, which is the downward direction in the plane of paper, in a direction substantially orthogonal to the plane of paper. Thus, the mirror surface guides the laser light L1 toward the detection target OB on the left side in the plane of paper. Part of the reflected light L2 reflected by the detection target OB follows a path that is the opposite of the path of the laser light L1, and is detected by the light receiving unit 20. That is, the reflecting mirror 31 again reflects the reflected light L2 reflected by the detection target OB, which is the return light, with the mirror surface of the reflecting portion 31a, and guides the reflected light to the side of the light receiving unit 20. When the reflecting mirror 31 rotates, the traveling direction of the laser light L1 changes in a plane orthogonal to the Z-axis direction (that is, the plane is the X-Y plane, and corresponds to the horizontal plane in a case where the Z-axis direction is the vertical direction). That is, the laser light L1 is scanned in the Y-axis direction, as the reflecting mirror 31 rotates. The detection region associated with the scanning of the laser light L1 spreads in the horizontal direction along the X-Y plane, and is narrow in the vertical Z direction. Note that the rotation axis RX of the reflecting mirror 31 extends parallel to the reference axis TX of the exterior component 50.

The control unit 40 controls operations of the laser light source of the light projecting unit 10, the sensor of the light receiving unit 20, the rotary drive unit 32 of the rotary reflecting unit 30, and the like. The control unit 40 also obtains object information about the detection target OB from an electrical signal converted from the reflected light L2 received by the sensor of the light receiving unit 20. Specifically, in a case where the output signal at the sensor is equal to or higher than a predetermined threshold, the control unit 40 determines that the sensor has received the reflected light L2 from the detection target OB. In this case, the distance to the detection target OB is calculated from the difference between the light emission timing at the laser light source and the light reception timing at the sensor. Further, object information such as the position, the size, the shape, and the like of the detection target OB can be obtained from the light reception position or the like of the reflected light L2 at the sensor.

The exterior component 50 is designed to cover and protect the internal components of the laser sensor device 100. The exterior component 50 includes the lid-like main exterior unit 51, and the sub exterior unit 52 in the form of a cylindrical container. Sealing members or the like are inserted into the edge portions 51a and 52a of the main exterior unit 51 and the sub exterior unit 52, to maintain the airtightness of the inside of the exterior component 50. In this state, the main exterior unit 51 and the sub exterior unit 52 are detachably secured with fasteners such as bolts.

[Mold for Forming an Exterior Component]

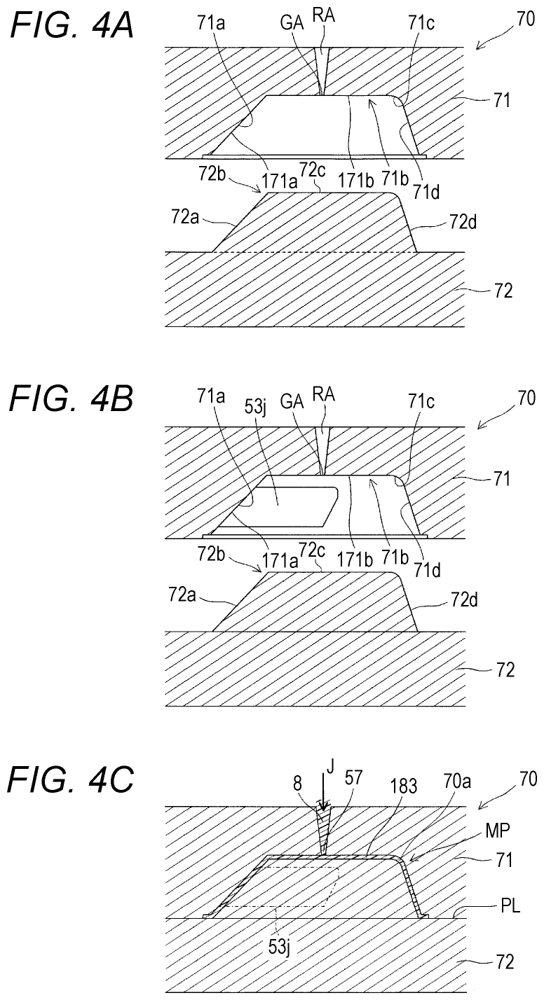

In the description below, an injection mold for forming the main exterior unit 51 of the exterior component 50 will be explained. As shown in FIG. 4A, an injection mold 70 includes a first mold 71 and a second mold 72. In this case, the first mold 71 is a fixed mold, and the second mold 72 is a movable mold. The transfer surface of the injection mold 70 is the reverse of the molded surface of the main exterior unit 51, which is a molded article. The first mold 71 and the second mold 72 are matched with each other in the mold matching plane PL, to form a molding space 70a between the molds 71 and 72 (see FIG. 4C). To face the molding space 70a, a first window transfer portion 71a and a first holder transfer portion 71b for transferring the shape of the surface side, which is the outer side, of the main exterior unit 51 are formed as the optical surface forming portion in the first mold 71. The first window transfer portion 71a is designed for transferring the shape of the first optical surface 53a of the optical window 53, and has a curved transfer surface and a mirror surface. The first holder transfer portion 71b is designed for transferring the shape of the surface side of the holding portion 54, and a first lid transfer portion 71c for transferring the shape of the lid portion 55, a first wall transfer portion 71d for transferring the shape of the wall portion 56, and the like are formed in the first holder transfer portion 71b. A second window transfer portion 72a and a second holder transfer portion 72b for transferring the shape of the back side, which is the inside, of the main exterior unit 51 are formed as the optical surface forming portion in the second mold 72. The second window transfer portion 72a is designed for transferring the shape of the second optical surface 53b of the optical window 53, and has a curved transfer surface and a mirror surface. The second holder transfer portion 72b is designed for transferring the shape of the back side of the holding portion 54, and a second lid transfer portion 72c for transferring the shape of the lid portion 55, a second wall transfer portion 72d for transferring the shape of the wall portion 56, and the like are formed in the second holder transfer portion 72b. The surfaces or the transfer surfaces of the first and second window transfer portions 71a and 72a are curved like a side surface of a circular cone, and have a substantially uniform gradient with respect to the reference axis TX of the exterior component 50. The first holder transfer portion 71b has a gate GA formed at a position relatively distant from the first window transfer portion 71a. The gate GA communicates with the molding space 70a. The gate GA is connected to a runner RA for supplying resin, a sprue (not shown), and the like. A molten resin J from the sprue fills the runner RA, and fills the molding space 70a through the gate GA.

[Exterior Component Manufacturing Method]

Referring now to FIGS. 4A to 4C and others, a method for manufacturing the main exterior unit 51 primarily using the injection mold 70 is described.

A) Insert Molding Process

First, both molds 71 and 72 are heated to a temperature suitable for molding, by a mold temperature controller (not shown).

Next, as shown in FIG. 4B, the optical film 53j is attached and fixed at the position corresponding to the first window transfer portion 71a of the first mold 71. The optical film 53j is held in the injection mold 70, having undergone the two processes: a provisional attachment process described later, and a main attachment process. Thus, formation of wrinkles can be prevented while positional deviation of the optical film 53j is prevented. A transfer surface 171a of the first window transfer portion (the optical surface forming portion) 71a has been subjected to surface finishing so that the Ra value of the surface roughness becomes 10 nm or smaller. On the other hand, a transfer surface 171b of the first holder transfer portion 71b has been subjected to surface finishing so that the Ra value of surface roughness becomes 10 nm or greater, but processing may be performed so that the Ra value of the surface roughness becomes 10 nm or smaller. Further, the functional surface 153j of the optical film 53j shown in FIG. 2 is in close contact with the transfer surface 171a of the first window transfer portion 71a, and the Ra value of the surface roughness thereof is 10 nm or smaller. The transfer surface 171a of the first window transfer portion (the optical surface forming portion) 71a preferably has 5 nm or smaller as the Ra value of its surface roughness, to secure a sticking force.

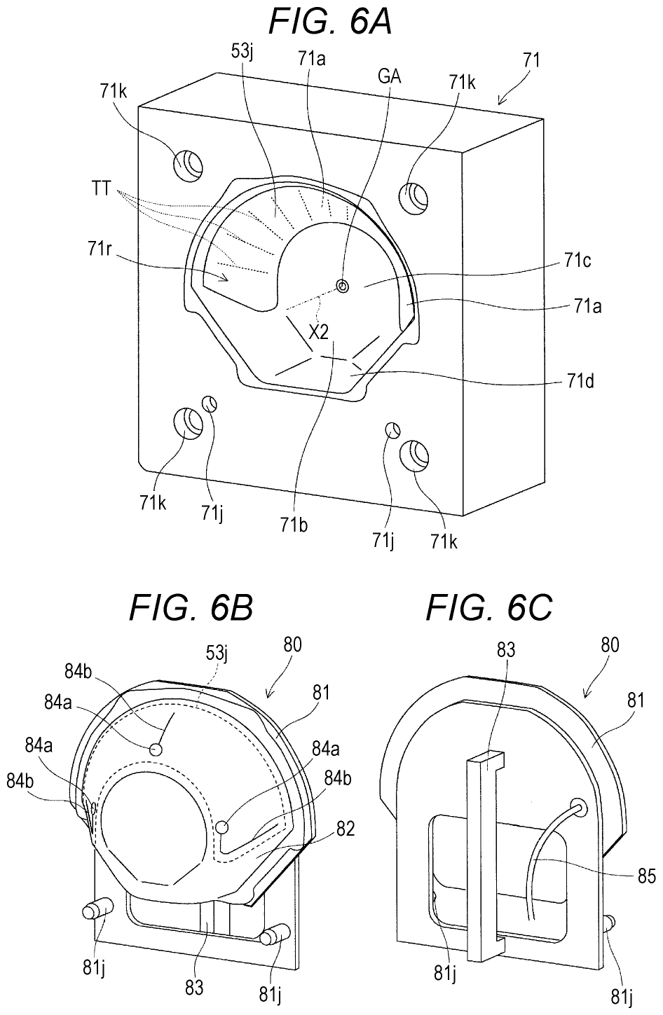

FIG. 6A is a perspective view specifically showing the transfer side of the first mold 71. The optical film 53j is attached and fixed to the first window transfer portion 71a of the first mold 71 in an aligned state.

FIG. 6B is a perspective view of the front side of a provisional attachment jig. FIG. 6C is a perspective view of the back surface side of the provisional attachment jig. A provisional attachment jig 80 includes a substrate 81, a support 82, and a handle 83. The substrate 81 supports the support 82, and has positioning pins 81j to be fitted into a plurality of positioning holes 71j formed in the first mold 71. The support 82 has the same shape as the main exterior unit 51 shown in FIG. 1A and others. The support 82 detachably supports the optical film 53j on its surface. A plurality of ventilation holes 84a are formed in the support 82, and ventilation grooves 84b extend from the respective ventilation holes 84a along the surface of the support 82. An air supply pipe 85 extends from the back surface of the substrate 81, and extends to an air-driven unit (not shown).

In the description below, the process of provisionally attaching the optical film 53j to the first mold 71 using the provisional attachment jig 80 will be explained. By the provisional attachment process, the optical film 53j is positioned with respect to the first window transfer portion (the optical surface forming portion) 71a. First, the optical film 53j is set on the support 82 of the provisional attachment jig 80, with its functional surface 153j facing upward. The ventilation holes 84a are set to a negative pressure via the air supply pipe 85. As a result, the optical film 53j is positioned and fixed onto the support 82. After that, the support 82, together with the optical film 53j, is fitted into a recess 71r of the first mold 71. As a result, the optical film 53j is brought into close contact with or close to the first window transfer portion 71a of the first mold 71. After that, the negative pressure of the air supply pipe 85 is canceled or is turned into a positive pressure, so that the optical film 53j sticks to the first window transfer portion 71a (see FIG. 6A). Here, the transfer surface 171a of the first window transfer portion (the optical surface forming portion) 71a comes into contact with the functional surface 153j of the optical film 53j. However, the transfer surface 171a does not completely come into contact with the functional surface 153j, but comes into contact locally with the functional surface 153j so that air bubbles or an air layer is interposed in between. However, at a portion where the transfer surface 171a and the functional surface 153j are in contact with each other, the portion is in a vacuum state, and therefore, the optical film 53j is held by the first window transfer portion 71a.

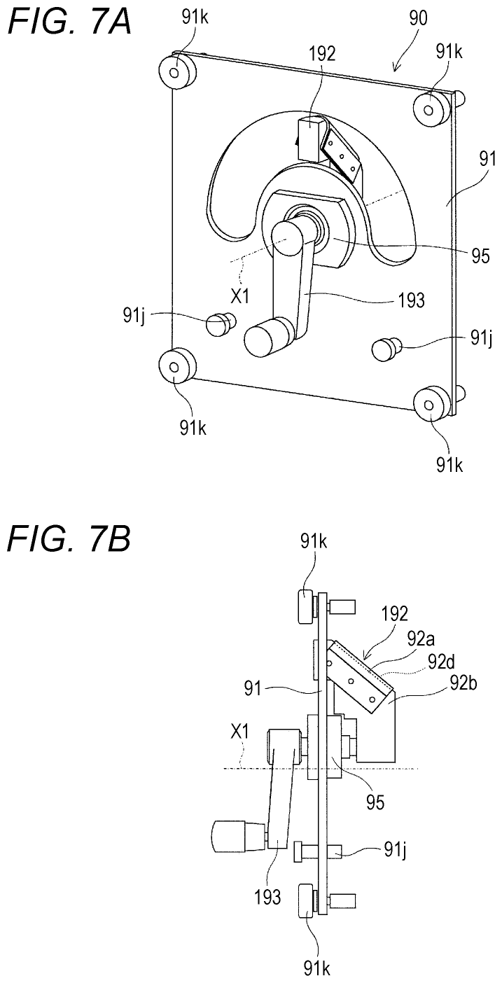

FIG. 7A is a perspective view of the back side of a main attachment jig. FIG. 7B is a side view of the main attachment jig. A main attachment jig 90 includes a substrate 91, a rotary member 192, and a handle 193. The substrate 91 supports the rotary member 192 via a bearing 95. The substrate 91 has a plurality of positioning pins 91j to be fitted into the plurality of positioning holes 71j formed in the first mold 71, and also has an adjustment member 91k having pins to be fitted into a plurality of positioning holes 71k formed in the first mold 71. The adjustment member 91k can adjust the distance between the substrate 91 and the first mold 71. The rotary member 192 is connected to the handle 193, and rotates, together with the handle 193, about a rotation axis X1. In a case where the main attachment jig 90 is attached to the first mold 71, the main attachment jig 90 is positioned so that the rotation axis X1 is aligned with an axis X2 (see FIG. 6A) corresponding to the reference axis TX of the main exterior unit 51 in the first mold 71. The rotary member 192 includes a sheet-like spatula portion 92a, and a support member 92b that detachably supports the spatula portion 92a. The spatula portion 92a is a spatula-like member made of silicone resin (or silicone rubber), and has an appropriate elasticity. The rubber hardness of the spatula portion 92a is 80 or lower in Shore hardness, or preferably 60 or lower in Shore hardness. The supporting surface 92d of the support member 92b is a cylindrical surface, and the spatula portion 92a presses the transfer surface 171a at a linear contact portion TT via the optical film 53j. When the support member 92b is rotated, the linear contact portion TT rotationally moves in a radial trajectory as shown in the drawing along the generatrix of the conical surface. That is, the spatula portion 92a has a structure similar to that of a squeegee that removes moisture or the like from the surface of an object. However, the spatula portion 92a is used for pushing out the air or the air layer remaining between the first window transfer portion (the optical surface forming portion) 71a and the optical film 53j by performing squeegeeing on the surface that is the back surface of the optical film 53j. The spatula portion 92a not only enables pressing of the optical film 53j against the first window transfer portion 71a with sufficient pressure, but also can reduce the friction with the surface of the optical film 53j and prevent formation of scratches.

In the description below, the process of attaching the optical film 53j permanently to the first mold 71 using the main attachment jig 90 will be explained. The main attachment process prevents wrinkles when the optical film 53j is integrated with the molded article body 53i. First, with the positioning pins 91j and the positioning holes 71j, the main attachment jig 90 is positioned and brought close to the first mold 71, so that the rotary member 192 is inserted into the recess 71r of the first mold 71. At this time, the adjustment member 91k adjusts the space between the substrate 91 and the first mold 71, so that the spatula portion 92a of the rotary member 192 presses the optical film 53j attached to the first window transfer portion 71a of the first mold 71 against the first window transfer portion 71a with an appropriate pressure. The pressing force with which the rotary member 192 presses the optical film 53j is adjusted to a value not smaller than 0.03 N/mm² and not greater than 0.2 N/mm². After that, the handle 193 is rotated clockwise or counterclockwise, so that the spatula portion 92a presses a local portion of the optical film 53j against the first window transfer portion 71a with a pressing force that is not smaller than 0.03 N/mm² and not greater than 0.2 N/mm², while rotationally moving. The pressing force generated by the spatula portion 92a is preferably not smaller than 0.05 N/mm² and not greater than 0.2 N/mm². As the spatula portion 92a presses the optical film 53j against the first window transfer portion 71a, the spatula portion 92a can move the air bubbles or the air layer having entered locally between the transfer surface 171a of the first window transfer portion (the optical surface forming portion) 71a and the functional surface 153j of the optical film 53j, from the center to the periphery. Eventually, the spatula portion 92a can push the air bubbles or the air layer to the outside. Thus, it is possible to prevent wrinkles and positional deviation of the optical film 53j at the time of integral film formation described later.

Here, the manufacturing of the optical film 53j fixed to the first mold 71 using the provisional attachment jig 80 and the main attachment jig 90 is described. The material of the hard coat layer 93 is applied, by an applicator, onto the film base material 92 formed with PET, PC, PMMA, TAC, or the like, while the film base material 92 is conveyed horizontally by rollers and the like. The applied material layer is then thermally hardened. Thus, the optical film 53j in which the hard coat layer 93 is formed on the film base material 92 can be obtained.

As a process after the optical film 53j is attached to the first mold 71, the first mold 71 and the second mold 72 are matched, as shown in FIG. 4C. After the mold matching, mold clamping is performed to tighten the first mold 71 and the second mold 72 with a required pressure.

Next, as shown in FIG. 4C, an injection system (not shown) injects the molten resin J into the molding space 70a with a required pressure. A resin that has transparency in the wavelength region of laser light, and preferably has lower transparency in the other wavelength regions is used as the molding resin. After the molding space 70a is filled with the resin, the injection mold 70 maintains the resin pressure in the molding space 70a, and gradually cools the molten resin J by releasing heat. In the above manner, a semi-molded article MP including a runner portion 8 corresponding to the runner RA, the gate portion 57 corresponding to the gate GA, and a product portion 183 (the original form of the main exterior unit 51 to be formed later) corresponding to the molding space 70a is formed.

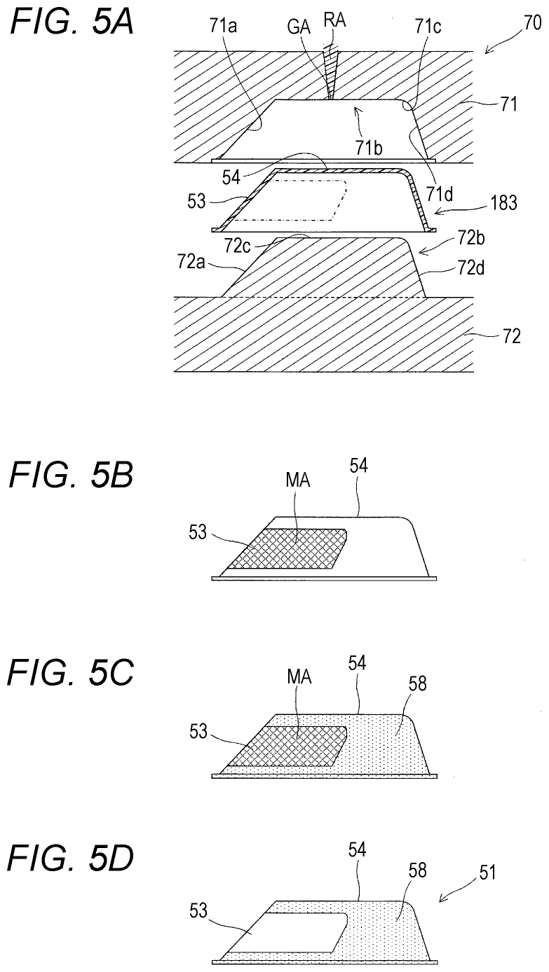

Next, as shown in FIG. 5A, mold opening for retracting the movable second mold 72 is performed. At this stage, a stripper plate (not shown) and the fixed first mold 71 are first separated from each other. As a result, the gate portion 57 is cut off from the semi-molded article MP. The first mold 71 and the second mold 72 are then separated from each other. As a result, the product portion 183 is released from the first mold 71 while being held by the second mold 72. After that, the product portion 183 is ejected by an ejector pin or the like (not shown). As a result, the product portion 183 is extruded toward the first mold 71, and is released from the second mold 72.

At the time of mold opening for retracting the movable second mold 72, a retrieving device (not shown) is operated to retrieve the product portion 183 from between the first and second molds 71 and 72, and carry the product portion 183 to the outside. The product portion 183 is a resin molded article in which the optical window 53 and the holding portion 54 are integrated. In the product portion 183, the optical film 53j is also integrated with the first optical surface 53a of the optical window 53, having been in close contact with the first optical surface 53a during the molding. Thus, even if the optical window 53 has a complicated shape, the optical film 53j, or the hard coat layer 93, can be uniformly provided. Since both the optical window 53 and the holding portion 54 have transparency to light, it is necessary to perform a light blocking process on the holding portion 54 in a later step.

B) Light Blocking Process

Next, the light blocking portion 58 is formed on the holding portion 54 of the product portion 183. Specifically, after a mask MA is formed on the first optical surface 53a of the optical window 53 as shown in FIG. 5B, a material that blocks laser light and ambient light is applied onto the outer surface of the holding portion 54 as shown in FIG. 5C. As the mask MA, a polyethylene masking film is used, for example. A masking film of polypropylene, polyester, or the like may be used, depending on the purpose of use. In this embodiment, the light blocking portion 58 is formed on the entire holding portion 54 of the main exterior unit 51. After the light blocking process, the mask MA is removed from the optical window 53, to obtain the main exterior unit 51, as shown in FIG. 5D. After that, with the internal components being incorporated into and secured in the separately manufactured sub exterior unit 52, the edge portion 51a of the main exterior unit 51 and the edge portion 52a of the sub exterior unit 52 are aligned with each other, and are secured with fasteners such as bolts via a sealing member formed with a material such as fluororubber for preventing dust and moisture. Thus, the laser sensor device 100 is completed.

### Examples

The following is a description of experiments concerning the sticking properties of optical films. A mold having a flat optical surface forming portion subjected to mirror finishing was prepared, and a plurality of optical films having different surface roughnesses were pressed against the optical surface forming portion, to observe the sticking states. The size of the mold was 40 mm×40 mm. The roughness of the mold surface was Ra=1.0 nm (the measurement range being 0.12 mm×0.09 mm). The base material of the optical films used was polycarbonate (PC), and a hard coat layer was formed as a functional layer on the base material. The thickness of the optical films was 100 μm. The relationship between the surface roughnesses of the optical films and the sticking states of the optical films is shown below. The evaluation criteria for the sticking properties are as follows: those that do not fall even when they are turned upside down are marked with ∘, and those that fall when they are turned upside down are marked with x.

TABLE 1

| Film surface roughness Ra (nm) | Mold sticking properties |
|---|---|
| 0.81 | ∘ |
| 2.8 | ∘ |
| 9.9 | ∘ |
| 27 | x |
| 35 | x |
| 42 | x |

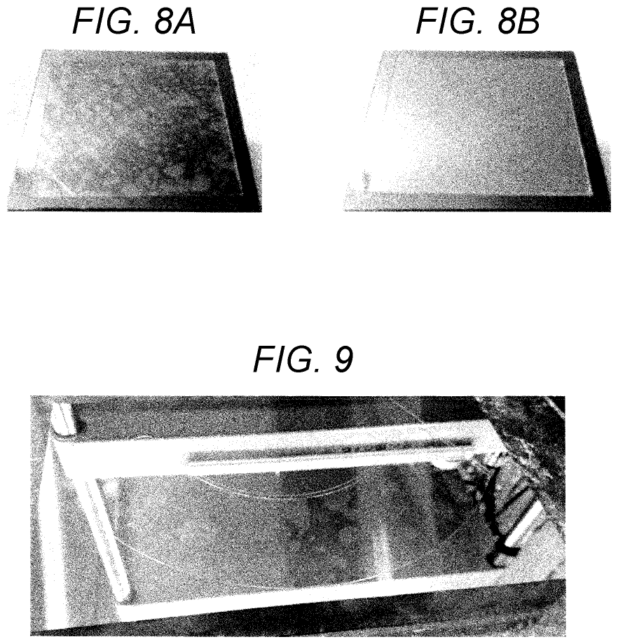

FIG. 8A shows the case where the value of the surface roughness Ra of the optical film is 9.9 nm or smaller. FIG. 8B shows the case where the value of the surface roughness Ra of the optical film is 27 nm or greater. In the example shown in FIG. 8A, the optical film sticks to the surface of the mold. In the example shown in FIG. 8B, however, the optical film does not stick to the surface of the mold, and is in a slippery state. In the example shown in FIG. 8A, a locally discolored portion is formed, but this is because a local air layer is formed between the mold surface and the optical film.

The following is a description of experiments concerning the sticking properties of optical films. A metallic flat plate having a flat surface subjected to mirror finishing was prepared, and an optical film was placed on the flat surface. Squeegeeing was performed on the optical film with a spatula having a silicone rubber attached to the tip thereof, and the state of the remaining air bubbles or the remaining air layer was observed. Here, the spatula has the same structure as the spatula portion 92a of the main attachment jig 90 shown in FIG. 7A. The relationship between pressing forces of the spatula on the optical film and contact areas excluding air bubbles is as follows.

TABLE 2

| Pressing force | Contact area | Pressing force | Evaluation on |
|---|---|---|---|
| (N) | (mm²) | (N/mm²) | remaining air bubbles |
| 4.90 | 200 | 0.0245 | x |
| 7.35 | 250 | 0.0294 | Δ |
| 14.70 | 300 | 0.0490 | ∘ |

In Table 2, symbol “x” means that there are still air bubbles remaining after the main attachment, and wrinkles are formed by the molding. Symbol “Δ” means that there remains a small amount of bubbles after the main attachment, but the wrinkles are not formed by the molding. Symbol “∘” means that there are no air bubbles remaining after the main attachment.

FIG. 9 shows a state in which an optical film is placed on a flat surface of a metallic flat plate, and air bubbles have not yet been removed by a spatula.

By the molded article manufacturing method described above, the functional surface 153j of the optical film 53j that is 10 nm or smaller in the Ra value of surface roughness is attached to the first window transfer portion (the optical surface forming portion) 71a of the injection mold 70 that is 10 nm or smaller in the Ra value of surface roughness. In this manner, the injection mold 70 is made to hold the optical film 53j. Accordingly, part of the contact region between the first window transfer portion (the optical surface forming portion) 71a and the optical film 53j is in a vacuum state, and the optical film 53j is held by the injection mold 70 without fail. This prevents positional deviation of the optical film 53j during injection molding, and enhances the adhesion between the optical film 53j and the molded article body 53i.

Although the present invention has been described with reference to an embodiment and examples, the present invention is not limited to the embodiment and the like described above. For example, the structures of the provisional attachment jig 80 and the main attachment jig 90 shown in the drawings are merely examples, and may have various structures depending on the shapes of various molded articles that are not necessarily exterior components of laser sensor devices.

For example, if the conditions for the operation and the pressing force for sequentially pushing out air bubbles from one edge are satisfied, various techniques may be adopted, such as rolling a roller or pushing an elastic material, instead of using the main attachment jig 90 shown in FIG. 7A.

Although the optical film 53j includes the hard coat layer 93 and the film base material 92 in the above description, a binder layer for improving sticking properties may be applied onto the back surface side of the film base material 92, which is the side of the molded article body 53i (the resin side), depending on the combination of the material of the film base material 92 and the material of the molded article body 53i.

Further, in the above embodiment, a case where the hard coat layer 93 is formed as the functional layer of the optical film 53j has been described. However, various kinds of functional layers may be formed on the film base material 92. A functional layer can have a function according to the purpose of use of the optical film 53j. For example, in the optical film 53j, an antireflection layer may be formed on the hard coat layer 93. An antireflection treatment is performed by transfer or decoration using a film, vapor deposition, sputtering, coating, or the like, for example.

Further, in the optical film 53j, the hard coat layer 93 and the other functional layers are not essential, and the film base material 92 can be attached as the optical film 53j to the injection mold 70. In this case, the surface of the film base material 92 may be designed to have a three-dimensional shape.

In the above embodiment, the transfer surface 171a of the first window transfer portion 71a provided in the injection mold 70 is a curved surface like a side surface of a circular cone. However, the shape of the transfer surface formed on an injection mold can be set as appropriate, in accordance with the purpose of use of a molded article that is an optical component. Specifically, the shape of the transfer surface may be a spherical surface, an aspherical surface, a free-form surface, or the like.

Further, in the embodiment described above, the internal components of the laser sensor device 100 and the layout thereof can be changed as appropriate.

1. A molded article manufacturing method comprising:
causing an injection mold to hold an optical film, by attaching a functional surface of the optical film to an optical surface forming part of the injection mold, an Ra value of surface roughness of the injection mold being not greater than 10 nm, an Ra value of surface roughness of the optical film being not greater than 10 nm; and
forming a molded article body and integrating the molded article body and the optical film, the molded article body being formed by supplying a molten resin into a mold space formed by the injection mold and hardening the molten resin.

2. The molded article manufacturing method according to claim 1, wherein a total thickness of the optical film is not smaller than 25 μm and not greater than 300 μm.

3. The molded article manufacturing method according to claim 1, wherein the optical film includes a functional layer on a functional surface side.

4. The molded article manufacturing method according to claim 3, wherein the functional layer is a hard coat layer.

5. The molded article manufacturing method according to claim 4, wherein the hard coat layer is made of a silicone resin.

6. The molded article manufacturing method according to claim 1, wherein the causing the injection mold to hold the optical film includes positioning the optical film with respect to the optical surface forming part; and preventing wrinkles when the optical film is integrated into the molded article body.

7. The molded article manufacturing method according to claim 6, wherein, during the positioning, squeegeeing is performed on a surface of the optical film with a spatula-like member made of a silicone rubber, to push out air bubbles remaining between the optical surface forming part and the optical film.

8. The molded article manufacturing method according to claim 6, wherein a pressing force for pushing out air is not smaller than 0.03 N/mm².

9. The molded article manufacturing method according to claim 2, wherein the optical film includes a functional layer on a functional surface side.

10. The molded article manufacturing method according to claim 2, wherein the causing the injection mold to hold the optical film includes: positioning the optical film with respect to the optical surface forming part; and preventing wrinkles when the optical film is integrated into the molded article body.

11. The molded article manufacturing method according to claim 3, wherein the causing the injection mold to hold the optical film includes: positioning the optical film with respect to the optical surface forming part; and preventing wrinkles when the optical film is integrated into the molded article body.

12. The molded article manufacturing method according to claim 4, wherein the causing the injection mold to hold the optical film includes: positioning the optical film with respect to the optical surface forming part; and preventing wrinkles when the optical film is integrated into the molded article body.

13. The molded article manufacturing method according to claim 5, wherein the causing the injection mold to hold the optical film includes: positioning the optical film with respect to the optical surface forming part; and preventing wrinkles when the optical film is integrated into the molded article body.

14. The molded article manufacturing method according to claim 7, wherein a pressing force for pushing out air is not smaller than 0.03 N/mm2.
